(19) United States
(12) Patent Application Publication
(10) Pub. No.: US 2019/0250420 A1
(43) Pub. Date: Aug. 15, 2019

(54) DISPLAY APPARATUS, INSTRUMENT METER INCORPORATING THE SAME, AND CLOCK INCORPORATING THE SAME

(71) Applicant: Alex Yung Kan Wong, Vancouver (CA)

(72) Inventor: Alex Yung Kan Wong, Vancouver (CA)

(21) Appl. No.: 16/265,011

(22) Filed: Feb. 1, 2019

Related U.S. Application Data
(60) Provisional application No. 62/710,125, filed on Feb. 12, 2018.

(51) Int. Cl. G02B 27/22; G01L 17/00; G04G 9/10; G02B 17/00; G02B 5/10

(52) U.S. Cl. CPC G02B 27/2292; G01L 17/00; G06F 3/017; G02B 17/004; G02B 5/10; G04G 9/10

(57) ABSTRACT

There is provided a display apparatus. The display apparatus includes an electronic display. The display apparatus includes first and second parabolic reflectors coupled together and facing each other. Each reflector has a vertex. The first parabolic reflector has an opening extending therethrough adjacent to the vertex thereof. The second parabolic reflector receives the electronic display adjacent to the vertex thereof.

### CROSS REFERENCE TO RELATED APPLICATIONS

This application is a non-provisional of U.S. Provisional Patent Application No. 62/710,125 filed in the United States Patent and Trademark Office on Feb. 12, 2018, and the disclosure of which is incorporated herein by reference and priority to which is claimed.

### BACKGROUND OF THE INVENTION

### Field of the Invention

There is provided a display apparatus. In particular, there is provided a display apparatus, an instrument meter incorporating the same, and a clock incorporating the same.

### Description of the Related Art

Display apparatuses, instrument meters and clocks are known per se to those skilled in the art. However, electronic displays thereof may be susceptible to damage. On the other hand there may also remain a need for electronic displays to provide an enhanced degree of visibility. Lastly, there may continue to be a need for a display apparatuses, instrument meters and clocks that include electronic displays in a novelty arrangement.

### BRIEF SUMMARY OF INVENTION

There is accordingly provided, and it is an object to provide, an improved display apparatus, instrument

There is accordingly provided a display apparatus. The display apparatus includes an electronic display. The display apparatus includes first and second parabolic reflectors coupled together and facing each other. Each reflector has a vertex. The first parabolic reflector has an opening extending therethrough adjacent to the vertex thereof. The second parabolic reflector receives the electronic display adjacent to the vertex thereof.

According to another aspect, there is provided a clock including the above-mentioned display apparatus.

According to a further aspect, there is provided a tire gauge assembly. The assembly includes a tire gauge operatively connectable to a tire so as to measure pressure thereof. The tire gauge includes a gauge display. The assembly includes first and second parabolic reflectors coupled together and facing each other. Each of the reflectors has a vertex. The first parabolic reflector has an opening extending therethrough adjacent to the vertex thereof. The second parabolic reflector receives the gauge display adjacent to the vertex thereof.

According to yet another aspect, there is provided a display apparatus. The apparatus includes an electronic display. The apparatus includes an upper parabolic reflector. The upper parabolic reflector has a peripheral portion and a vertex spaced-apart from the peripheral portion thereof. The upper parabolic reflector has an opening extending therethrough adjacent to the vertex thereof. The apparatus includes a lower parabolic reflector. The lower parabolic reflector has a peripheral portion and a vertex spaced-apart the peripheral portion thereof. The peripheral portion of the lower parabolic reflector is substantially equal in size to the peripheral portion of the upper parabolic reflector. The lower parabolic reflector couples with and faces the upper parabolic reflector via said peripheral portions. The lower parabolic reflector receives the electronic display adjacent to the vertex thereof. The electronic display is visible from the exterior of the apparatus from a top perspective view of the apparatus and from at least one of a top side perspective view of the apparatus, a top rear perspective view of the apparatus and a top front perspective view of the apparatus.

### BRIEF DESCRIPTION OF DRAWINGS

The invention will be more readily understood from the following description of preferred embodiments thereof given, by way of example only, with reference to the accompanying drawings, in which:

FIG. 1 is a top, right side perspective view of a display apparatus according to a first aspect, the apparatus including first and second parabolic mirrors shown coupled together and facing each other, and the apparatus including a gauge display with an image thereof shown above an opening of the first parabolic mirror;

FIG. 2 is a top, right side perspective view of the second parabolic mirror and gauge display of the display apparatus of FIG. 1, with the first parabolic mirror not being shown;

FIG. 3 is top plan view thereof.

FIG. 4 is a bottom plan view thereof;

FIG. 5 is a bottom, right side perspective view of the first parabolic mirror of the display apparatus of FIG. 1;

FIG. 6 is a top plan view thereof;

FIG. 7 is a front, left side perspective view of the display apparatus of FIG. 1;

FIG. 8 is a top plan view of the display apparatus of FIG. 1;

FIG. 9 is a sectional view taken along lines 9-9 of the display apparatus of FIG. 8;

FIG. 10 is a sectional view taken along lines 10-10 of the display apparatus of FIG. 8, with the gauge display seen within the second parabolic mirror, an image of the gauge display seen above the first parabolic mirror, and a person's hand shown in the process of moving in a swiping motion above the display apparatus within a predetermined range of a motion detector of the display apparatus to turn off the gauge display;

FIG. 11 is a sectional view of the display apparatus of FIG. 10, with the gauge display seen within the second parabolic mirror, the gauge display shown turned off, and an image of the gauge display no longer seen above the first parabolic mirror;

FIG. 12 is a sectional view of the display apparatus of FIG. 10, with the gauge display seen within the second parabolic mirror, a person's hand shown in the process of moving in a swiping motion above the display apparatus within a predetermined range of a motion detector of the display apparatus to turn on the gauge display, and the image of the gauge display accordingly seen above the first parabolic mirror once more;

FIG. 13 is a flowchart of the algorithm for selectively turning on and off the gauge display of the display apparatus of FIG. 1;

FIG. 14 is a perspective view of a tire gauge assembly incorporating the display apparatus of FIG. 1; and

FIG. 15 is a top elevation view of a clock incorporating the display apparatus of FIG. 1.

### DESCRIPTION OF THE PREFERRED EMBODIMENTS

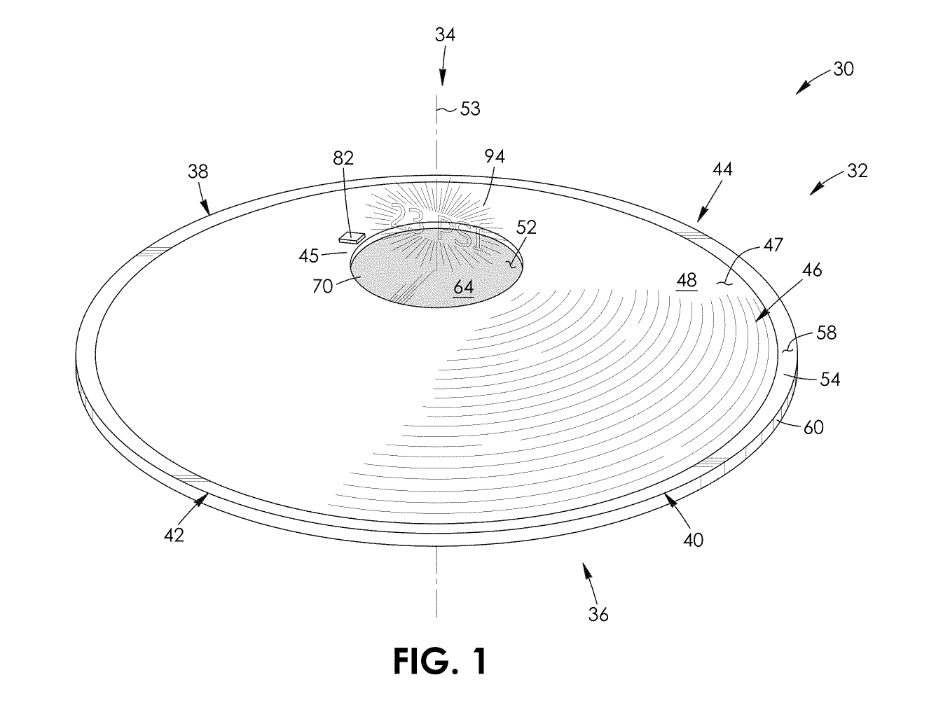

Referring to the drawings and first to FIG. 1, there is shown a display apparatus 30. The apparatus has an exterior 32, a top 34, a bottom 36, a pair of spaced-apart sides 38 and 40 extending between the top and the bottom thereof, a front 42 and a rear 44. The front and rear of the apparatus extend between the sides of the apparatus, and extend between the top and the bottom of the apparatus. References to top, bottom, side, front and rear as herein described are not intended to be limiting, are used with reference to and from the perspective of the Figures, and are used only for the purposes of illustration and facilitating description of the apparatus. Thus what is referred to as top 34 in FIG. 1 may be a side or bottom in other example, depending on the configuration of the apparatus 30.

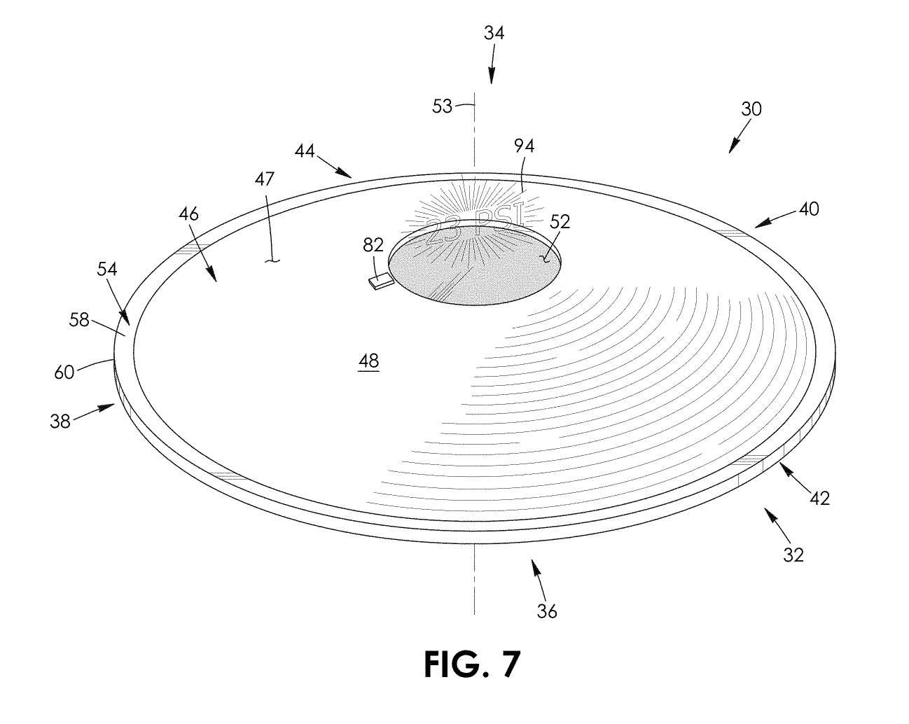

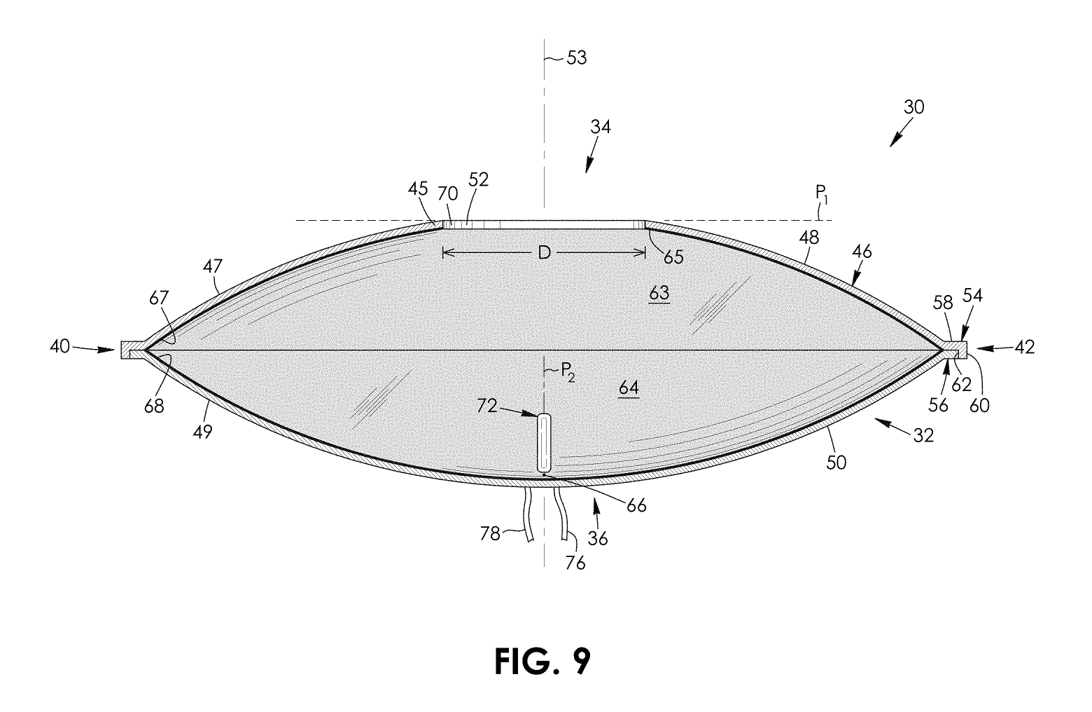

As seen in FIG. 7, the apparatus 30 includes a housing 46. The housing is made of plastic in this example and is convex-lens like in shape. However, this is not strictly required and the housing made be made of other materials and have other shapes in other examples. The housing has a first or upper portion 47 which extends from the top 34 towards the bottom 36 of the apparatus. The upper portion of the housing has an exterior surface 48 that is generally convex in this example. As seen in FIG. 9, the housing 46 has a second or lower portion 49 which extends from the bottom 36 towards the top 34 of the apparatus 30. The lower portion of the housing has an exterior surface 50 which in this example is generally convex. As seen in FIG. 1, the housing has a centrally-positioned aperture 52 extending therethrough adjacent to the top 34 of the apparatus 30 in this example. The aperture is circular in this example. The apparatus 30 has a central axis 53 which is co-axial with the aperture 52 and about which the housing 46 extends in this example. The housing 46 includes a peripheral portion 45 that is annular in this example and which extends about aperture 52 thereof.

Referring to FIG. 9, the upper portion 47 and lower portion 49 of the housing 46 selectively couple together via mating flanges 54 and 56 that are annular in this example. Flange 54 is L-shaped in lateral cross-section, with a radially-extending portion 58 and an axially-extending portion 60 coupled to and extending perpendicular to the radially-extending portion thereof. The radially-extending portion and axially-extending portion of the flange form an annular seat 62 within which flange 56 is received in this example.

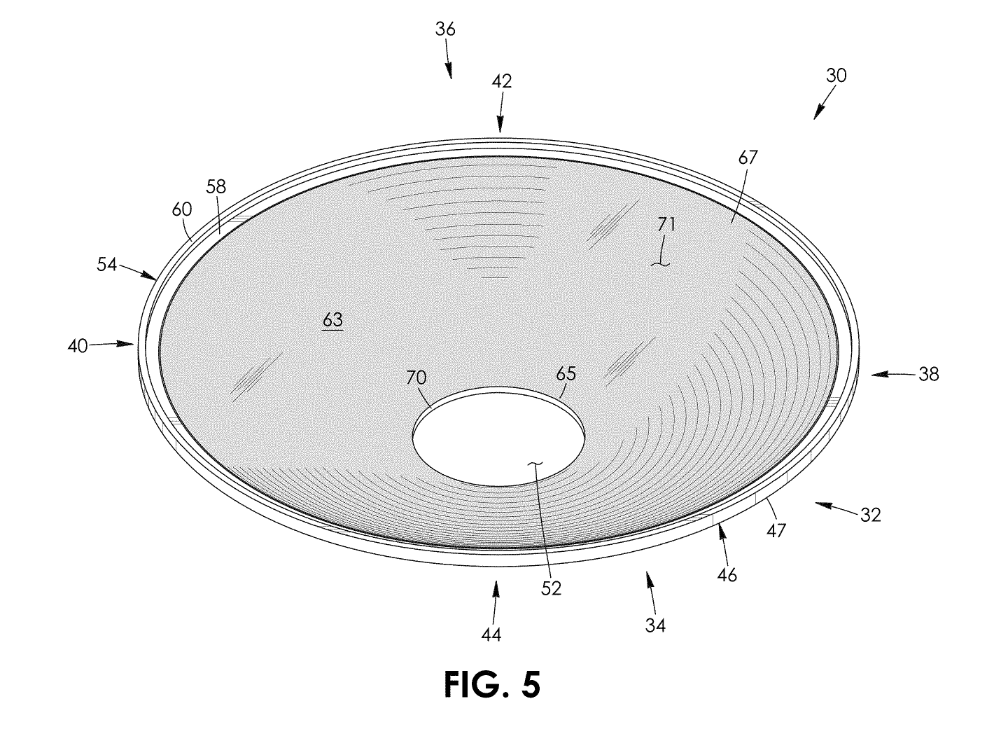

As seen in FIG. 5, the display apparatus 30 includes a first parabolic reflector, in this example a first parabolic mirror 63. The mirror is saucer-like in shape, and is mounted to and positioned within upper portion 47 of housing 46 in this example. The mirror 63 has an interior concave surface 71 that is reflective. The mirror has a vertex 65 which aligns with aperture 52 of the housing 46 and which is adjacent to the top 34 of the apparatus 30 in this example. The mirror 63 has a peripheral portion 67 which is annular and spaced-apart from the vertex thereof. Flange 54 extends about the mirror 63 adjacent to the peripheral portion of the mirror. As seen in FIG. 9, the mirror 63 faces downwards from the perspective of FIG. 9 and extends from the vertex 65 thereof towards to the bottom 36 of the apparatus 30. The mirror 63 has an opening 70 extending therethrough adjacent to the vertex 65 thereof. The opening aligns with and is substantially equal in size as aperture 52 of the housing 46 in this example. The opening 70 of the mirror 63 is circular in this example and has a diameter D.

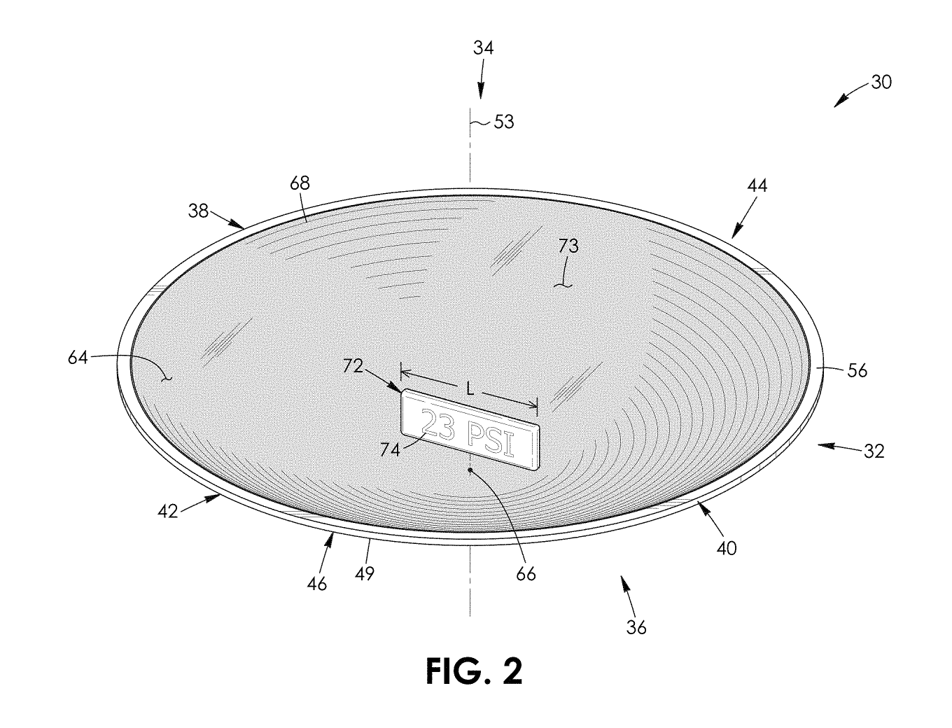

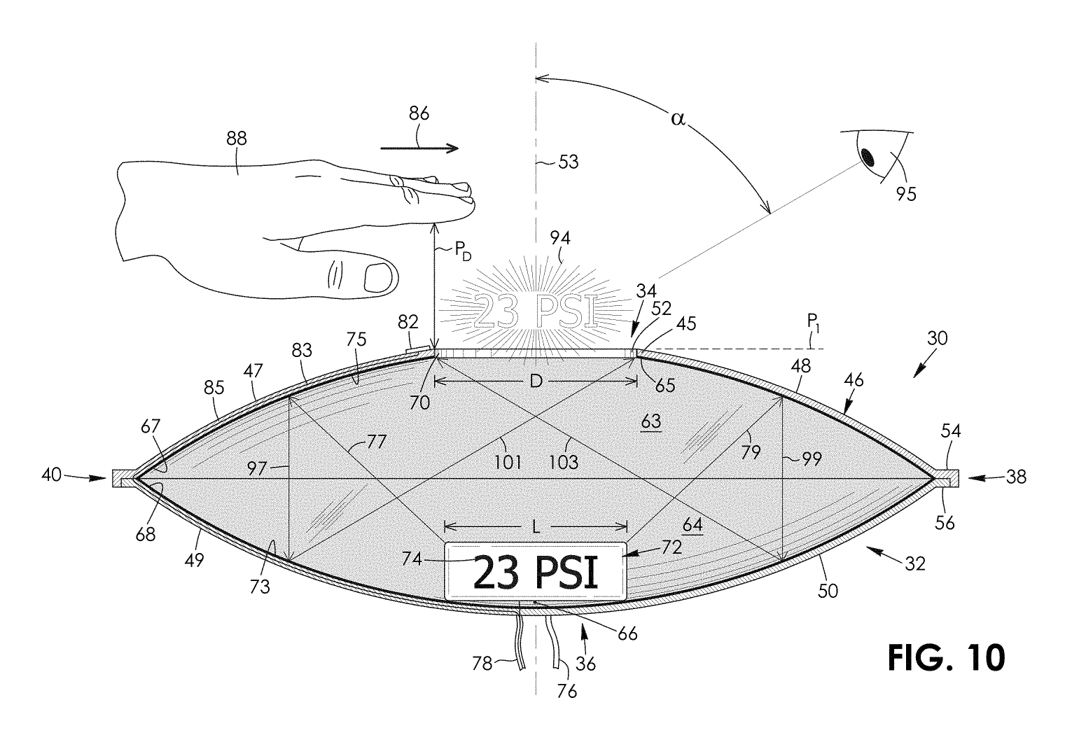

Referring to FIG. 2, the apparatus includes a second parabolic reflector, in this example a second parabolic mirror 64. The mirror is saucer-like in shape, and is mounted to and positioned within lower portion 49 of housing 46 in this example. The mirror 64 has an interior concave surface 73 that is reflective. The mirror has a vertex 66 which aligns with axis 53 and which is adjacent to the bottom 36 of the apparatus 30 in this example. The mirror 64 faces upwards from the perspective of FIG. 2 and extends from the vertex 66 thereof towards to the top 34 of the apparatus 30. The mirror 64 has a peripheral portion 68 which is annular and spaced-apart from the vertex thereof. Flange 56 extends about the mirror 63 adjacent to the peripheral portion of the mirror. As seen in FIG. 9, the peripheral portion 67 of mirror 63 is substantially equal in size to and selectively couples with the peripheral portion 69 of mirror 64 in this example. As seen in FIG. 10, the mirrors 63 and 64 are coupled together and their reflective surfaces 71 and 73 face each other, with peripheral portions 67 and 68 thereof being adjacent and abutting each other. The mirrors are co-axial with and extend about axis 53.

As seen in FIG. 2, the apparatus 30 includes an electronic display, in this example in the form of a digital display, in this case a light-emitting diode (LED) gauge display 72. However, this is not strictly required and the electronic display may comprise others forms and types in other embodiments. The gauge display 72 aligns with axis 53 and displays indicia 74, in this example “23 PSI”, with PSI meaning pounds per square inch. The gauge display is generally a rectangular prism in shape in this example and has a length L which extends perpendicular to axis 53. Mirror 64 is shaped to receive the gauge display 72 adjacent to the vertex 66 of the mirror. As seen in FIG. 10, the length L of the gauge display is equal to or less than the diameter D of the opening 70 of mirror 63 in this example. Referring to FIG. 9, the opening of the mirror extends within a first plane P₁ and the gauge display 72 extends within a second plane P₂. Plane P₂ is substantially perpendicular to plane P1 in this example. The mirrors 63 and 64 are shaped to enclose the gauge display and inhibit damage thereto.

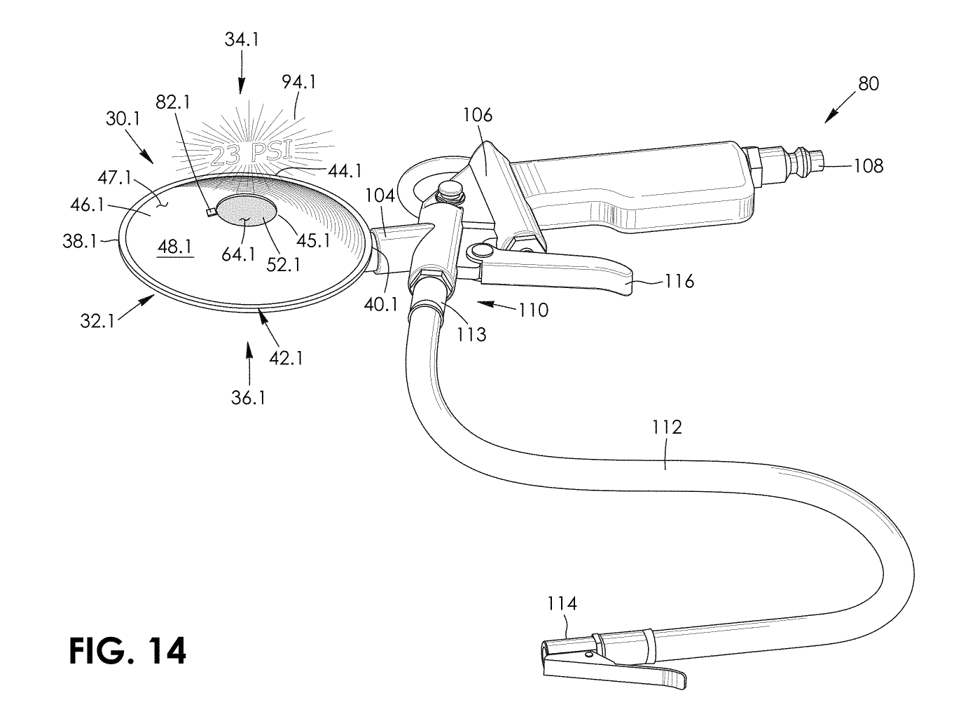

As seen in FIG. 10, the gauge display 72 includes a data input cable 76 that operatively connects to an output device, in this example an instrument meter, such as tire gauge assembly 80 seen in FIG. 14 in this example. The cable thus enables the gauge display 72 to receive display input therefrom. The gauge display includes a power cable 78 operatively coupled thereto. The gauge display connects to a power source (not shown) via said power cable.

As seen in FIG. 1, the apparatus 30 includes a motion detector 82. The motion detector is an off-the-shelf component, in this example a PIR D203S human movement sensor that may be purchased from Shenzhen Haiwang Sensor Co., Ltd. having an address of Room 1004, West-CBD, Binhe Blvd, Futian District, Shenzhen, China.

The motion detector 82 couples to and faces outwards from the peripheral portion 45 of the housing 46 on the upper portion 47 of the housing. As seen in FIG. 10, the motion detector 82 in this example is thus operatively connected to mirror 63. The motion detector is operatively connected to the gauge display 72, in this example via electrical conductor 83. A passageway 85 extends through the walls 87 of the housing 46 and the electrical conductor extends through the passageway. The electrical conductor 83 thus couples to and is enclosed by the housing.

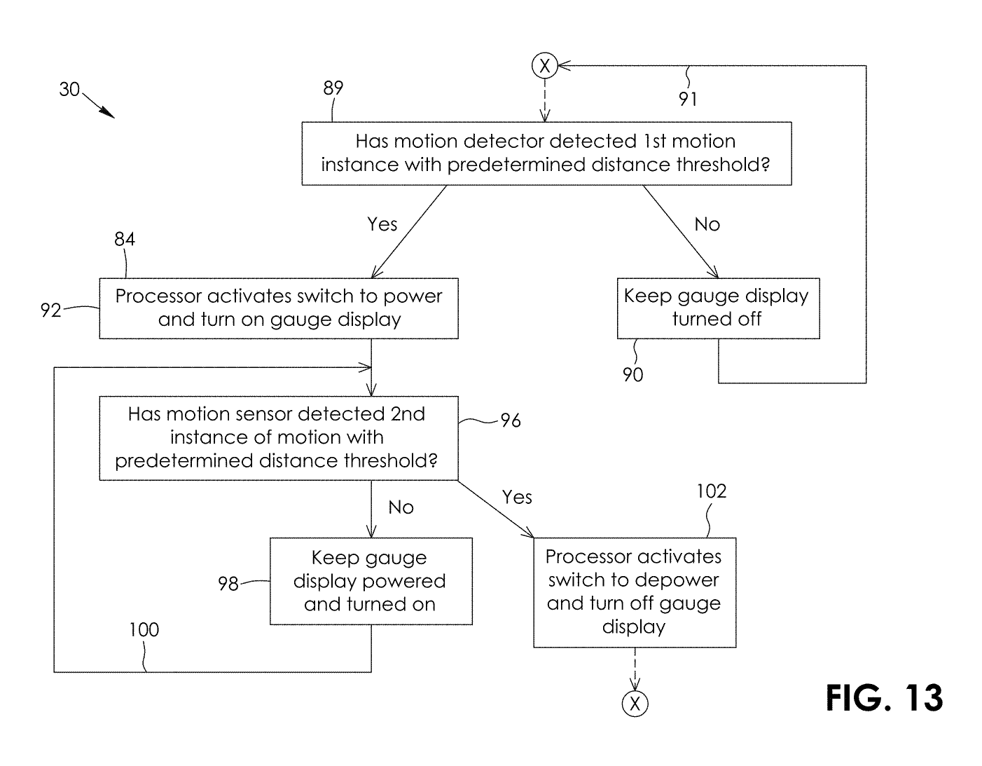

The apparatus 30 includes in this example a computer processor as seen in FIG. 13 by box of numeral 84. The processor operatively connects to the gauge display 72 and the motion detector 82 seen in FIG. 10. The motion detector determines if a first instance of motion is detected within a predetermined distance, as shown by box of numeral 89. Referring to FIG. 10, the motion, in this example, is a swiping motion 86 of a person's hand 88, detected by the motion detector in a first instance within predetermined distance PD threshold. Referring back to FIG. 13, if no such motion is detected, the processor maintains the gauge display in a depowered state and waits from further communication from the motion detector, as shown by box 90 and return loop 91. If such motion is detected, the motion detector communicates a signal reflecting the same to the processor. The processor in response thereto causes the gauge display to receive power and turn on, as shown by box 92. The gauge display 72 is shown turned on and powered in FIG. 10.

Still referring to FIG. 10, the mirrors 63 and 64 are shaped to form a hologram-like image 94 of the gauge display above and adjacent to the opening 70 of mirror 63. The focal point of mirror 64 is adjacent to the vertex 65 of mirror 63, and the focal point of mirror 63 is adjacent to the vertex 66 of mirror 64. Thus, when gauge display 72 is turned on and emits light rays 77 and 79, at least some of these rays reflect off mirror 63 towards mirror 64, as shown by arrows of numerals 97 and 99. Said reflected rays in turn reflect off mirror 63 towards vertex 65, as shown by arrows of numerals 101 and 103. A person's eye 95 sees the reflective rays passing through opening 70 and sees image 94 which appears to be floating above opening 70. This is phenomenon is known per se and thus will not be described in further detail. The mirrors are thus shaped to create an optical illusion of the gauge display being adjacent to the opening of the mirror, with the image being shown in a more pronounced and visible manner when the gauge display 72 is turned on. The gauge display is visible from the exterior 32 of the apparatus 30 from a top perspective view of the apparatus, from at least one of a top side perspective view of the apparatus, from a top rear perspective view of the apparatus and from a top front perspective view of the apparatus.

Referring to FIG. 10, image 94 of the gauge display 72 is visible from a range of locations spanning between plane P1 and axis 53. The range of locations span about the axis. At least one of the gauge display 72 and the image 94 thereof is visible from an acute angle α relative to the axis. The acute angle is equal to or less than approximately 60 degrees in this example. As the person's eyes 95 move closer to the opening 70 from axis 53, image 94 is no longer seen and only the gauge display 72 itself is seen.

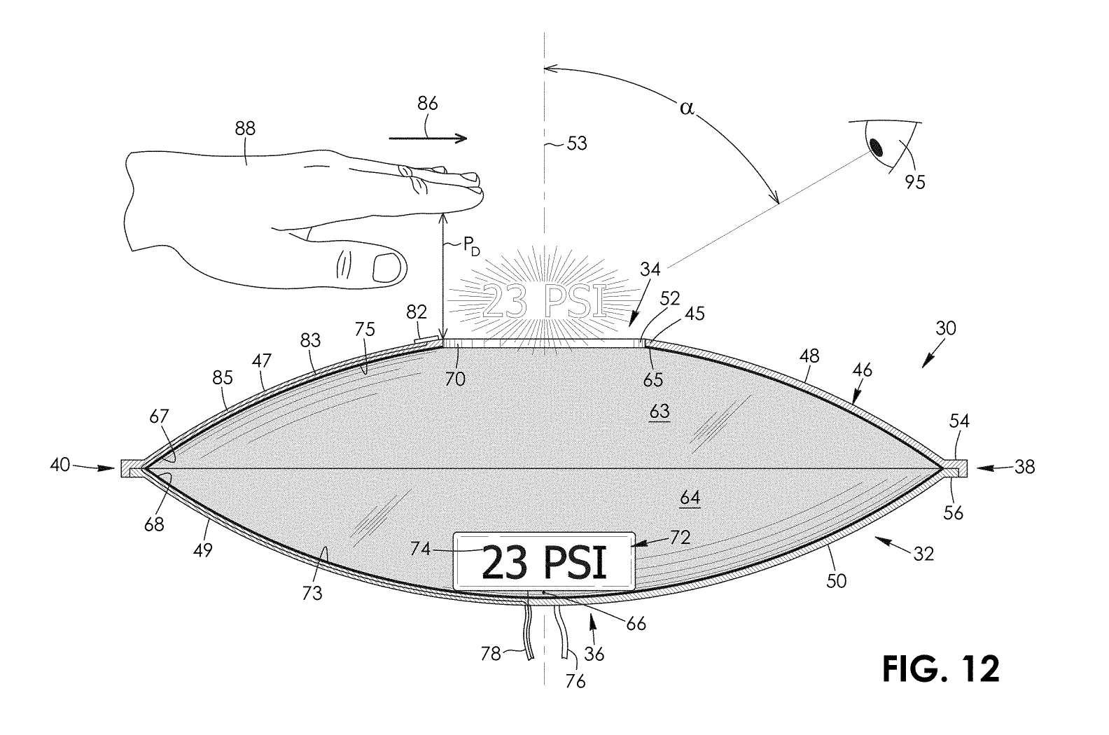

Referring back to FIG. 13, the processor next determines if motion is detected by the motion detector in a second instance thereafter within the predetermined distance, as shown by box 96. If no such detection signals are received by the processor, the processor continues to keep the gauge display powered and turned on, as shown by box 98 and return loop 100. If such motion is detected within the predetermined threshold PD, the motion detector communicates the same via electrical conductor 83 seen in FIG. 10, or wireless means, to the processor to turn off the electronic display, as seen by box 102 in FIG. 13. Thus, actuation of the motion detector 82 in a second instance, seen in FIG. 12 by swipe motion 86 of hand 88, depowers and turns off the gauge display 72. Referring back to FIG. 13, the process and sequence loops once more to box 89.

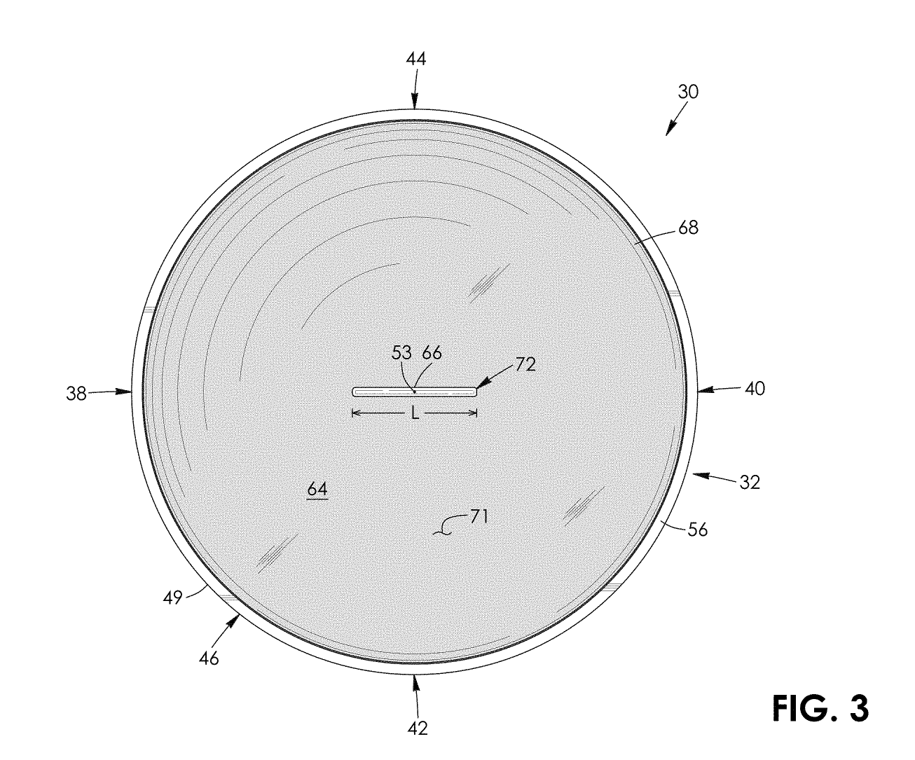

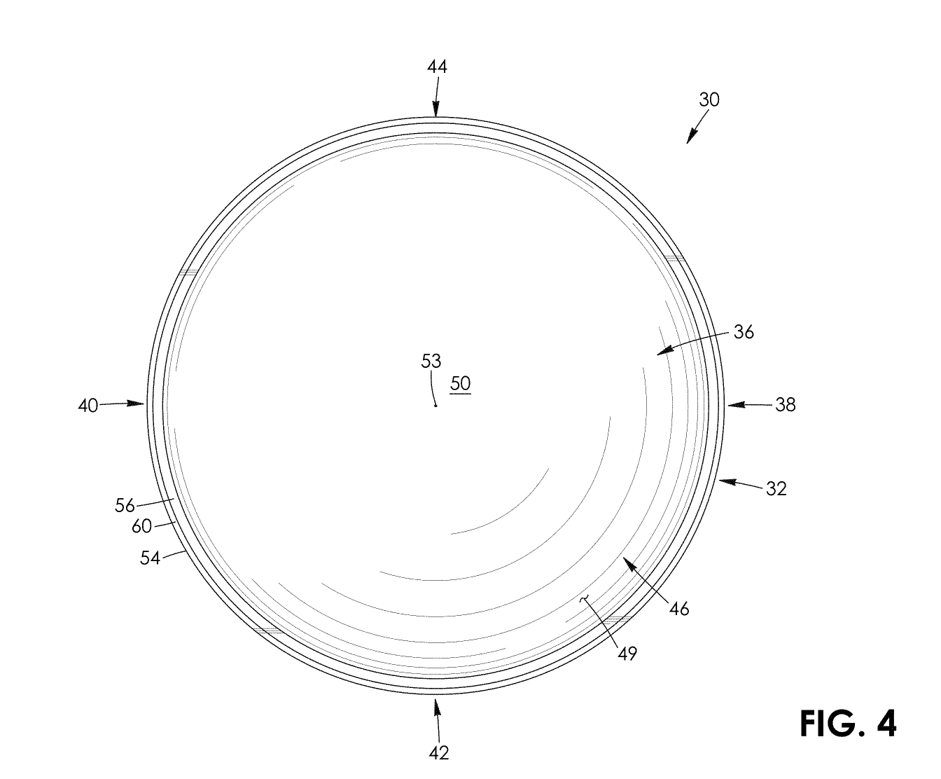

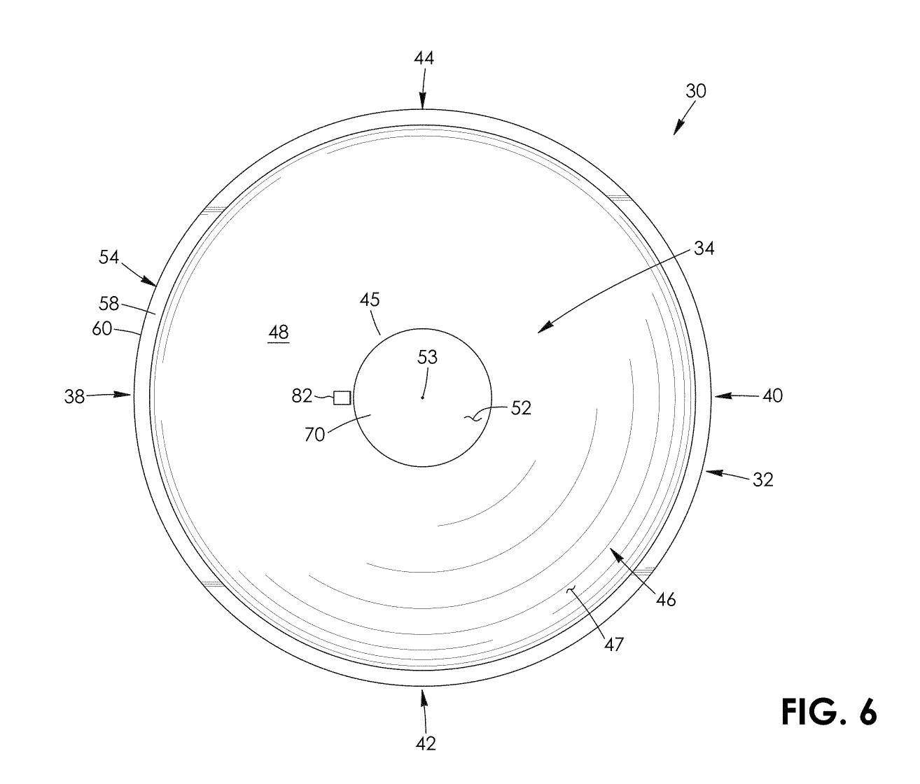

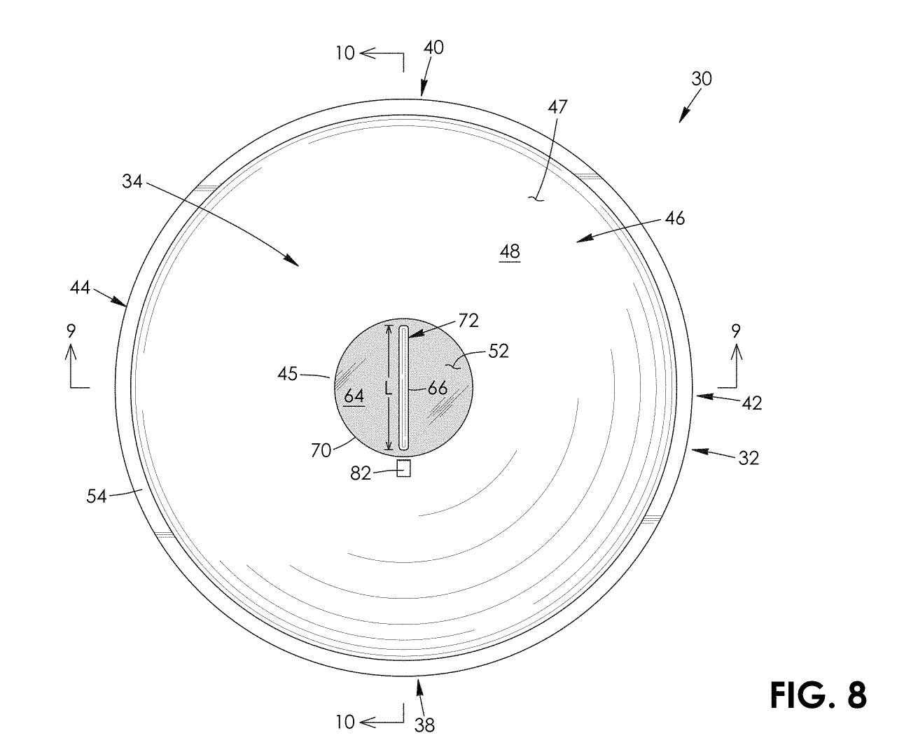

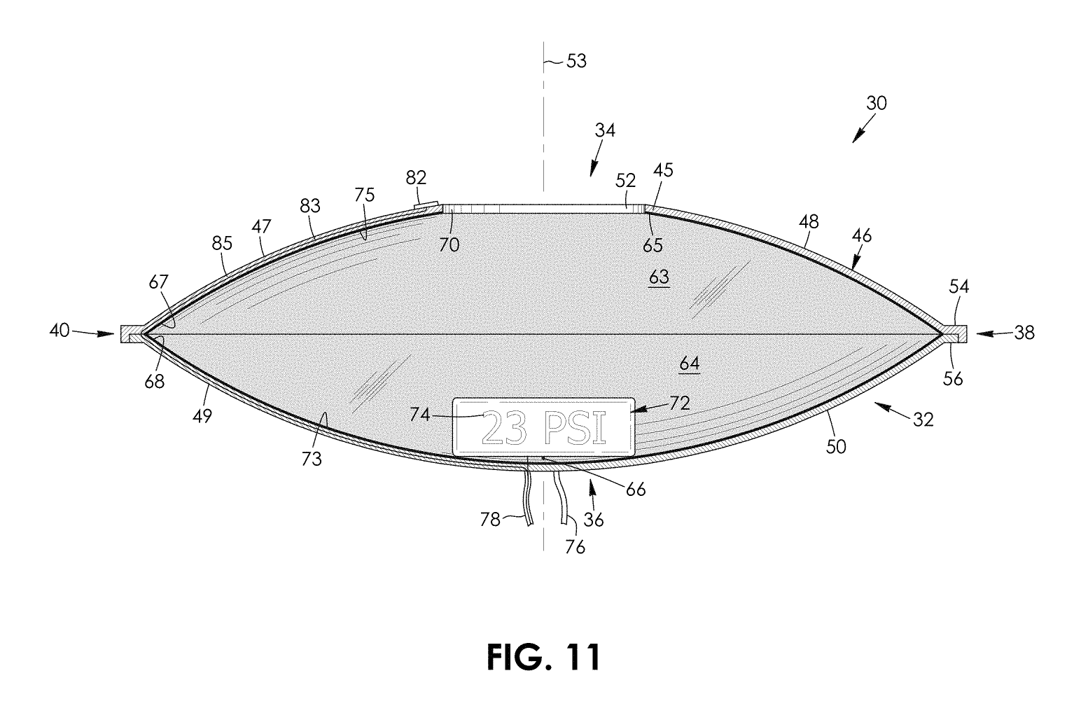

FIG. 14 shows a display apparatus 30.1 according to a second aspect. Like parts have like numbers and functions as the display apparatus 30 shown in FIGS. 1 to 13 with the addition of decimal extension “0.1”. Display apparatus 30.1 is substantially the same as display apparatus 30 shown in FIGS. 1 to 13 with the exception that it is shown as part of an instrument meter, in this example tire gauge assembly 80.

The assembly includes housing 104 and an air pressurizer 106 coupled to the housing. The air pressurizer is connectable to a pressurized air source (not shown) via coupler 108. The assembly 80 includes a gauge, in this example a tire gauge 110. The assembly includes an air line 112 operatively connected to the air pressurizer 106 via a first end 113 thereof. The air line is connectable to a tire (not shown) via a second end 114 thereof. The tire gauge 110 is operatively connectable to the tire so as to measure the pressure thereof. The tire gauge includes a gauge display, of which image 94.1 is seen in FIG. 14, which displays the pressure reading. Selective actuation of the air pressurizer 106 via handle 116 causes pressurized air to pass through the air line and into the tire to selectively inflate the tire to a desired amount.

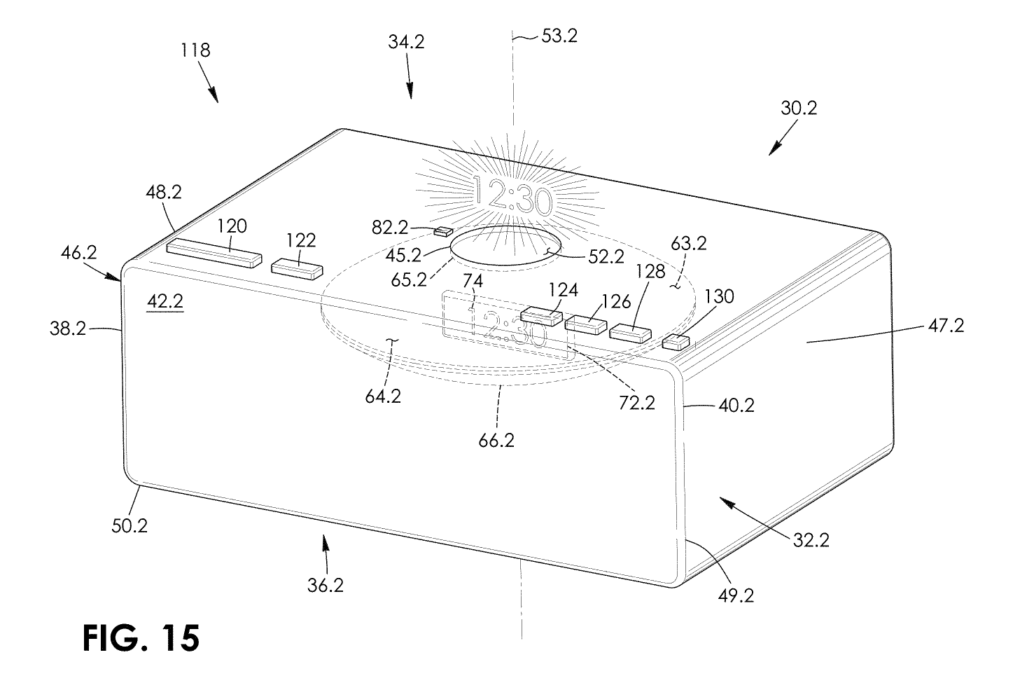

FIG. 15 shows a display apparatus 30.2 according to a third aspect. Like parts have like numbers and functions as the display apparatus 30 shown in FIGS. 1 to 13 with the addition of decimal extension “0.2”. Display apparatus 30.2 is substantially the same as display apparatus 30 shown in FIGS. 1 to 13 with the exception that it is shown as part of a clock 118. The clock has a snooze button 120, an alarm button 122, a time hour button 124, a time minute button 126, a radio dial 128 and an on-off switch 130.

Gauge displays, motion detectors, processors, air pressurizers, tire gauges, clocks and the like, including their various parts and functions, are known per se and will thus not be described in further details.

The display apparatuses as herein described may enable the viewer thereof to see the electronic displays from a multitude of angles on the one hand, thereby promoting ease of operation/viewing, while the housing thereof as a whole may function to enclose the electronic display and inhibit damage thereto.

It will be appreciated that many variations are possible within the scope of the invention described herein. It will be understood by someone skilled in the art that many of the details provided above are by way of example only and are not intended to limit the scope of the invention which is to be determined with reference to at least the following claims.

What is claimed is:

1. A display apparatus comprising:
an electronic display; and
first and second parabolic reflectors coupled together and facing each other, each said reflector having a vertex, the first parabolic reflector having an opening extending therethrough adjacent to the vertex thereof, and the second parabolic reflector receiving the electronic display adjacent to the vertex thereof.

2. The apparatus as claimed in claim 1 wherein the electronic display is a light-emitting diode (LED) display.

3. The apparatus as claimed in claim 1, wherein the apparatus has an axis, the opening and the parabolic reflectors being co-axial with and extending about the axis, wherein the opening extends within a plane, and wherein an image of the electronic display is visible from a range of locations spanning between the plane and the axis.

4. The apparatus as claimed in claim 3 wherein the range of locations spans about the axis.

5. The apparatus as claimed in claim 1 wherein the apparatus has an axis, the opening and the parabolic reflectors being co-axial with and extending about the axis, and wherein at least one of the electronic display and an image thereof is visible from an acute angle relative to the axis.

6. The apparatus as claimed in claim 5 wherein the acute angle is equal to or less than approximately 60 degrees.

7. The apparatus as claimed in claim 1 wherein the reflectors are shaped to enclose the electronic display and inhibit damage thereto.

8. The apparatus as claimed in claim 1 wherein the opening of the first parabolic reflector extends within a first plane and wherein the electronic display extends within a second plane substantially perpendicular to the first plane.

9. The apparatus as claimed in claim 1 wherein the opening of the first parabolic reflector has a diameter and wherein the electronic display has a length equal to or less than the diameter of the opening of the first parabolic reflector.

10. The apparatus as claimed in claim 1 further including a motion detector coupled to the first parabolic reflector, the motion detector being in electronic communication with the electronic display, with the electronic display selectively turning on upon the motion detector sensing motion within a predetermined range thereof.

11. The apparatus as claimed in claim 10 further including a housing within which the reflectors are mounted, the housing including a peripheral portion that extends about the opening of the first parabolic reflector, and wherein the motion detector couples to and faces outwards from said peripheral portion.

12. The apparatus as claimed in claim 10 wherein the apparatus includes a housing within which the reflectors are mounted, the housing including one or more walls, wherein a passageway extends through said one or more walls and extends between the motion detector and the electronic display, and wherein the apparatus includes electrical conductor coupling together the motion detector and the electronic display, the electrical conductor extending through the passageway.

13. The apparatus as claimed in claim 1 wherein the electronic display includes data input and power cables coupled thereto, the data input cable connecting to an instrument meter and enabling the electronic display to receive display input therefrom, and wherein the apparatus further includes a motion detector electronically connecting to the electronic display via the power cable, actuation of the motion detector in a first instance depowering and turning off the electronic display and actuation of the motion detector in a second instance powering and turning on the electronic display.

14. A clock comprising the display apparatus as claimed in claim 1.

15. A tire gauge assembly comprising:
a tire gauge operatively connectable to a tire so as to measure pressure thereof, the tire gauge including a gauge display; and
first and second parabolic reflectors coupled together and facing each other, each said reflector having a vertex, the first parabolic reflector having an opening extending therethrough adjacent to the vertex thereof, and the second parabolic reflector receiving the gauge display adjacent to the vertex thereof.

16. The assembly as claimed in claim 15 wherein the reflectors are shaped to form an image of the gauge display seen when viewing the opening of the first parabolic reflector at an angle.

17. The assembly as claimed in claim 15 wherein the reflectors and the opening extend about an axis and wherein at least one of the gauge display and an image thereof are visible from a range of acute angles relative to said axis.

18. A display apparatus comprising:
an electronic display;
an upper parabolic reflector having a peripheral portion, a vertex spaced-apart from the peripheral portion, and an opening extending therethrough adjacent to the vertex thereof; and
a lower parabolic reflector having a peripheral portion and a vertex spaced-apart the peripheral portion thereof, the peripheral portion of the lower parabolic reflector being substantially equal in size to the peripheral portion of the upper parabolic reflector, the lower parabolic reflector coupling with and facing the upper parabolic reflector via said peripheral portions, the lower parabolic reflector receiving the electronic display adjacent to the vertex thereof, whereby the electronic display is visible from the exterior of the apparatus from a top perspective view of the apparatus and from at least one of a top side perspective view of the apparatus, a top rear perspective view of the apparatus and a top front perspective view of the apparatus.

19. The display apparatus as claimed in claim 18 further including a motion detector coupled to one of the reflectors and a processor operatively connected to the electronic display and the motion detector, whereby detection of motion by the motion detector in a first instance within a predetermined distance threshold causes the processor to turn on the electronic display and whereby detection of motion by the motion detector in a second instance thereafter within a predetermined distance threshold causes the processor to turn off the electronic display.

20. The display apparatus as claimed in claim 18 wherein said motion is a swipe of a person's hand in sufficient proximity with the motion detector and as determined by the processor.
